(19) United States
(12) Patent Application Publication
(10) Pub. No.: US 2013/0082563 A1
(43) Pub. Date: Apr. 4, 2013

(54) DISK MOTOR, ELECTRIC WORKING MACHINE INCLUDING THE SAME AND METHOD FOR ADJUSTING BALANCE OF DISK MOTOR

(71) Applicant: Kenichirou Yoshida, Ibaraki (JP)

(72) Inventor: Kenichirou Yoshida, Ibaraki (JP)

(73) Assignee: HITACHI KOKI CO., LTD., Tokyo (JP)

(21) Appl. No.: 13/599,533

(22) Filed: Aug. 30, 2012

(30) Foreign Application Priority Data
Sep. 30, 2011 (JP) 2011-216083

(51) Int. Cl. H02K 7/04

(52) U.S. Cl. 310/208

(57) ABSTRACT

A disk motor including: a coil disk to which a coil pattern is formed; an electric current supply part configured to supply electric current to the coil pattern; a magnetic flux generating part opposed to the coil pattern; and an output shaft configured to be rotated by a rotational force of the coil disk, wherein the coil disk includes a balancing area at an outer periphery side of the coil pattern.

### CROSS-REFERENCE TO RELATED APPLICATIONS

This application claims priority from Japanese Patent Application No. 2011-216083 filed on Sep. 30, 2011, the entire contents of which are incorporated herein by reference.

### TECHNICAL FIELD

Aspects of the present invention relate to a disk motor including a coil disk and rotationally driving an output shaft thereof, an electric working machine including the same and a method for adjusting balance of the disk motor.

### BACKGROUND

A disk motor disclosed in Japanese Patent Publication No. 3636700 includes an output shaft, an approximately disk-shaped coil disk fixed to the output shaft and to which a coil pattern is formed, a commutator connected to the coil pattern, a magnet disposed to face the coil pattern and a brush for applying electric current to the commutator.

A rotational number of the disk motor is determined in accordance with a voltage supplied from the brush, an electric current of the disk motor, a coil pattern of the coil disk, a magnetic flux of the magnet and a number of the brushes (a number of poles). When the voltage supplied from the brush and the electric current of the disk motor are constant, it is possible to set the rotational number of the disk motor at a desired rotational number by changing the coil pattern of the coil disk, the magnetic flux of the magnet and the number of the brushes.

When the disk motor is used at a high rotational number, problems such as vibration due to unbalance of the motor (particularly, rotor), increase in noise and further decrease in an output power of the motor may occur. Accordingly, it is important that the disk motor is balanced during a manufacturing process thereof. In the disk motor disclosed in Japanese Patent Publication No. 3636700, a balancer is provided at a gap of the coil pattern in individual coil board. In a disk motor disclosed in JP-A-2011-078255 and JP-A-2011-078256, unbalance (unbalance of weight relative to the rotation axis) of the rotor is corrected by providing an opening on a yoke or flange of the rotor or adding a weight thereon.

### SUMMARY

In the disk motor disclosed in Japanese Patent Publication No. 3636700, it is possible to correct unbalance of individual coil board. However, it is difficult to correct the unbalance after a plurality of coil boards are assembled together. In the disk motor disclosed in JP-A-2011-078255 and JP-A-2011-078256, the correction is carried out at a side close to an output shaft relative to an outer diameter of the rotor. Accordingly, the amount of work (for providing an opening or adding a weight) is increased when a large balance adjustment is carried out. As a result, there is a problem that it is difficult to perform an adjustment work. Further, in JP-A-2011-078255, when forming an opening, a coil pattern exists on an extension line of the opening in a depth direction. Accordingly, there is a difficulty in forming the opening without damaging the coil pattern.

The present invention has been made to solve the above-described problems and an object of the present invention is to provide a disk motor in which the balance adjustment can be carried out at a position remote from the output shaft, as compared to JP-A-2011-078255 and JP-A-2011-078256. In this way, balance adjustment can be carried out greatly with less amount of work and a damage risk of the coil pattern is reduced. Further, the rotor can be balanced after the assembling of the rotor is completed. In addition, the present invention provides an electric working machine including such a disk motor and a method for adjusting the balance of the disk motor.

According to an aspect of the invention, there is provided a disk motor including: a coil disk to which a coil pattern is formed; an electric current supply part configured to supply electric current to the coil pattern; a magnetic flux generating part opposed to the coil pattern; and an output shaft configured to be rotated by a rotational force of the coil disk, wherein the coil disk includes a balancing area at an outer periphery side of the coil pattern.

According to another aspect of the invention, there is provided an electric working machine including the above-described disk motor.

According to another aspect of the invention, there is provided a method for adjusting balance of a disk motor, the disk motor including a coil disk to which a coil pattern is formed, an electric current supply part configured to supply electric current to the coil pattern, a magnetic flux generating part opposed to the coil pattern and an output shaft configured to be rotated by a rotational force of the coil disk, and the coil disk including a balancing area on an outer periphery side of the coil pattern, the method including; forming a hole or a notch to the balancing area.

According to another aspect of the invention, there is provided a method for adjusting balance of a disk motor, the disk motor including a rotor having a commutator disk and at least one coil disk to which a coil pattern is formed, an electric current supply part configured to supply electric current to the coil pattern, a magnetic flux generating part opposed to the coil pattern and an output shaft configured to be rotated by a rotational force of the coil disk, the rotor including a balancing area at an outer periphery portion thereof, and an outside pattern is formed to a portion of the balancing area which is not a surface that contacts with another board, the method including: forming a protrusion made of a conductive material on the outside pattern.

Any combinations of the above components and a modification thereof are also effective as an embodiment of the present invention.

According to the present invention, since the balancing area is provided in an outer periphery, it is possible to adjust the balance of the disk motor using the balancing area. For this reason, the balance adjustment can be carried out at a position remote from the output shaft, as compared to JP-A-2011-078255 and JP-A-2011-078256. Further, a large balance adjustment can be carried out with less amount of work and a damage risk of the coil pattern is reduced. Furthermore, the rotor can be balanced after the assembling of the rotor is completed.

### BRIEF DESCRIPTION OF DRAWINGS

FIG. 1 is a perspective view illustrating a mower as an electric working machine according to an embodiment of the present invention;

FIG. 2 is a front cross-sectional view illustrating a driving part of the mower illustrated in FIG. 1;

FIG. 3 is a schematic plan view illustrating a stator illustrated in FIG. 2;

FIG. 4 is a front view illustrating a rotor illustrated in FIG. 2, in which the left half thereof is illustrated in a cross-sectional view;

FIG. 5 is a plan view illustrating a commutator board illustrated in FIG. 4;

FIG. 6A is a plan view illustrating a first coil disk illustrated in FIG. 4 and FIG. 6B is a bottom view illustrating the first coil disk;

FIG. 7 (7A, 7B) is a view explaining a coil pattern of the first coil disk;

FIG. 8 is a partial enlarged plan view illustrating a rotor of which balancing area is provided with a balancing hole;

FIG. 9 is a partial enlarged plan view illustrating a rotor of which balancing area is provided with a balancing notch; and

FIG. 10 is a partial enlarged plan view illustrating a rotor in which a balancing protrusion is provided on a balancing pattern.

### DETAILED DESCRIPTION

Hereinafter, a preferred embodiment of the present invention will be described by referring to the accompanying drawings. The same or similar reference numerals are applied to the same or similar parts and elements throughout the drawings, and the duplicated description thereof will be omitted. Further, the embodiment is illustrative and not intended to limit the present invention. It should be noted that all the features and their combinations described in the embodiment are not necessarily considered as an essential part of the present invention.

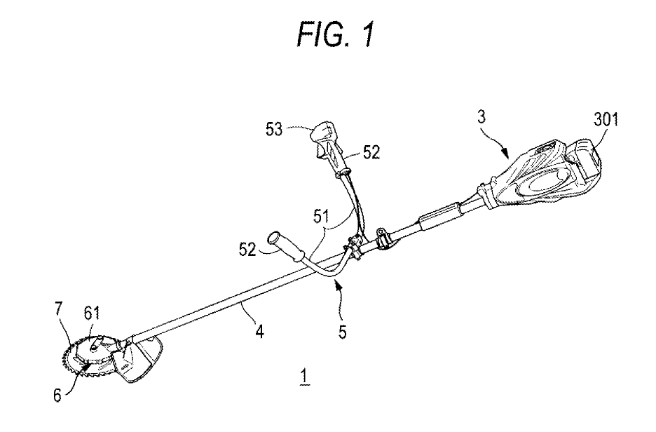

FIG. 1 is a perspective view illustrating a mower 1 according to an embodiment of the present invention. The mower 1 as an example of an electric working machine includes a power supply part 3, a pipe part 4, a handle part 5, a driving part 6 and a cutting blade 7.

The power supply part 3 includes a removable battery 301 as a power supply. The pipe part 4 mechanically connects the power supply part 3 and the driving part 6. Further, wirings (not-illustrated) electrically connecting the power supply part 3 and the driving part 6 are inserted in the inside of the pipe part 4. Power is supplied from the power supply part 3 to the driving part 6 via the wirings. The driving part 6 includes a head housing 61 in which a disk motor is accommodated and is configured to rotationally drive the cutting blade by the power supplied from the power supply part 3. The configuration of the disk motor will be described later.

The handle part 5 is fixedly attached to the middle of the pipe part 4, i.e., between the power supply part 3 and the driving part 6. The handle part 5 is composed by mounting a grip 52 on a leading end of a pair of arms 51, respectively. One grip 52 is provided with a throttle 53. As an operator operates the throttle 53, it is possible to adjust the power supplied to the driving part 6. That is, it is possible to adjust a rotational number of the cutting blade 7. The cutting blade 7 is formed in an approximately disk shape and provided at its peripheral edge with serrations. Further, the cutting blade 7 is provided at its central portion with a hole (not-illustrated). The hole is mounted to an output shaft of the disk motor.

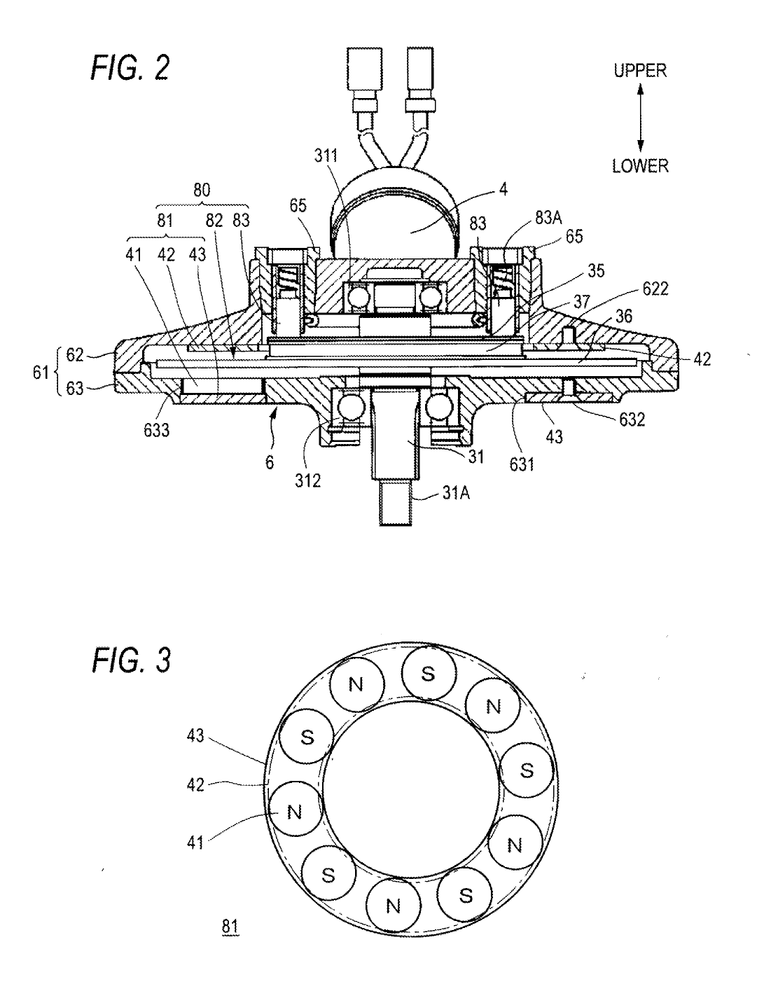

FIG. 2 is a front cross-sectional view illustrating the driving part 6 of the mower 1 illustrated in FIG. 1. As illustrated in FIG. 2, the extending direction of an output shaft 31 is defined as a vertical direction. The driving part 6 includes a disk motor 80 which is accommodated in a head housing 61. The head housing 61 is composed by integrally fitting a cover part 62 and a base part 63. The disk motor 80 includes a stator 81, a rotor 82 and a pair of brushes 83. The pair of brushes 83 are symmetrically provided with respect to a rotational shaft (output shaft 31) of the disk motor 80 and supported on a brush holder 65 of the cover part 62. Each brush 83 is urged (downward) toward a commutator board 35 (will be described later) by a spring 83A so that a lower surface thereof contacts a commutator pattern made of conductor such as a copper on the commutator board 35. The brush 83 is connected to the power supply part 3 of FIG. 1 and serves as an electric current supply part to supply electric current to a coil pattern (will be described later) of the rotor 82.

The stator 81 includes a magnet 41 as a magnetic flux generating part, an upper yoke 42 and a lower yoke 43. The upper yoke 42 and the lower yoke 43 are made of soft magnetic material. The upper yoke 42 is formed into a ring shape and fixed to a lower surface of the cover part 62 by a screw 622, for example. The lower yoke 43 is formed into a ring shape which has a diameter substantially the same as the diameter of the upper yoke 42. The lower yoke 43 is fixed into a ring-shaped groove 631 formed on a lower surface of the base part 63 by a screw 632, for example. The magnet 41 is fixedly fitted into a hole part 633 which is formed on an upper surface of the base part 63.

FIG. 3 is a schematic plan view illustrating the stator 81 illustrated in FIG. 2. As illustrated in FIG. 3, the magnets 41 are formed into a disk shape, for example. Further, a plurality of (for example, ten) magnets 41 are disposed side by side in an equiangular pitch on a circumference of the stator. In addition, the same number of the hole parts 633 of FIG. 2 accommodating the magnets 41 are placed side by side on a circumference thereof. The center of the circumference is substantially coincident with a rotation center of the disk motor 80. The magnetic pole of upper surface in adjacent magnets 41 is different from each other. Although a rare earth magnet such as a neodymium magnet can be desirably used as the magnet 41, a sintered magnet such as a ferrite magnet may be used. The upper yoke 42 and the lower yoke 43 are intended to increase the magnetic flux density applied to the coil pattern of the rotor 82 which will be described later.

As illustrated in FIG. 2, the rotor 82 includes the output shaft 31 (rotor shaft), the commutator board 35, a coil part 36 and a flange 37. The output shaft 31 is rotatably supported by an upper bearing 311 fixed to the cover part 62 and a lower bearing 312 fixed to the base part 63. A male screw 31A is formed on a lower side end of the output shaft 31 and the cutting blade 7 of FIG. 1 is fixed to the male screw 31A by a fastener (not-illustrated). The upper surface of the commutator board 35 is a sliding surface of the brush 83. Electric current is supplied from the power supply part 3 illustrated in FIG. 1 to the coil part 36 via the brush 83 and the commutator board 35.

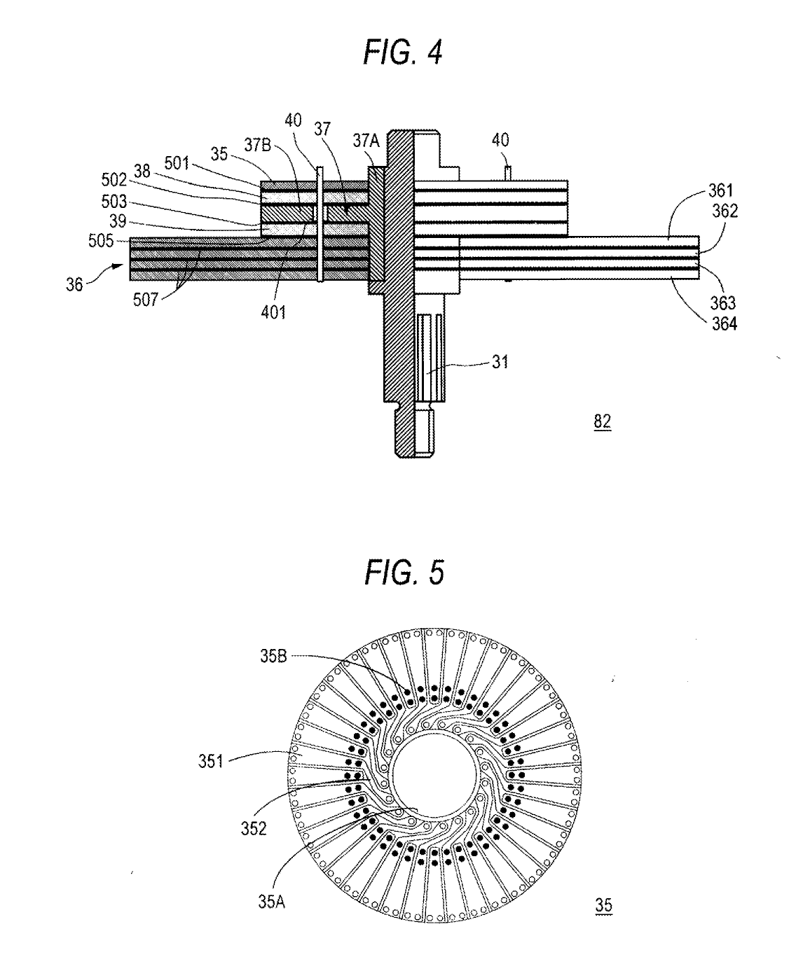

FIG. 4 is a front view illustrating the rotor 82 illustrated in FIG. 2, in which the left half thereof is illustrated in a cross-sectional view. As illustrated in FIG. 4, a flange 37 made of metal such as aluminum is coaxially fixed to the output shaft 31. The flange 37 includes a cylinder part 37A formed in a substantially cylindrical shape and a disk part 37B formed in a substantially disk shape. The disk part 37B is projected outward from the side of the cylinder part 37A in a vertical direction relative to the output shaft 31. Insulation plates 38, 39 and sheet-like (insulation) adhesive layers 502, 503 have the same shape as the disk part 37B, as viewed in an axial direction. The insulation plates 38, 39 are fixedly adhered to an upper and lower surface of the disk part 37B by the sheet-like adhesive layers 502, 503. The commutator board 35 is fixedly adhered to an upper surface of the insulation plate 38 by the sheet-like (insulation) adhesive layer 501. The coil part 36 is fixedly adhered to a lower surface of the insulation plate 38 by the sheet-like (insulation) adhesive layer 505.

The coil part 36 is formed by laminating a first coil disk 361 to a fourth coil disk 364 while sandwiching a sheet-like (insulation) adhesive layer 507 therebetween, respectively. The sheet-like adhesive layer 507 has the same shape as each coil disk as viewed in an axial direction and covers substantially the entire surface of each coil disk. The first coil disk 361 to fourth coil disk 364 have a diameter larger than that of the disk part 37B and a coil pattern, which will be described later, is formed to both surfaces thereof, respectively. A conductor pin 40 penetrates through the commutator board 35 to the fourth coil disk 364. The conductor pin electrically connects a commutator pattern of the commutator board 35 and a coil pattern of at least one of the first coil disk 361 to the fourth coil disk 364. An insulation pipe 401 is fitted into a through-hole (insertion hole for the pin 40) of the disk part 37B to ensure insulation between the pin 40 and the flange 37.

FIG. 5 is a plan view illustrating the commutator board 35 illustrated in FIG. 4. The cylinder part 37A of FIG. 4 is inserted into a through-hole 35A which is provided at the center of the disk-shaped commutator board 35 (commutator disk). Pin insertion holes 35B are provided at a predetermined number in positions equidistant from the center of the commutator board 35 and the pin 40 illustrated in FIG. 4 is selectively inserted into some of the pin insertion holes 35B. A commutator pattern 351 formed on the commutator board 35 is radially divided into 40 segments. For example, two segments (the first segment and the ninth segment, or the second segment and the tenth segment, etc.) between which seven segments are interposed are connected to each other by a connection pattern (not-illustrated) which is formed to a surface opposite to a connection pattern 352 that is formed inside.

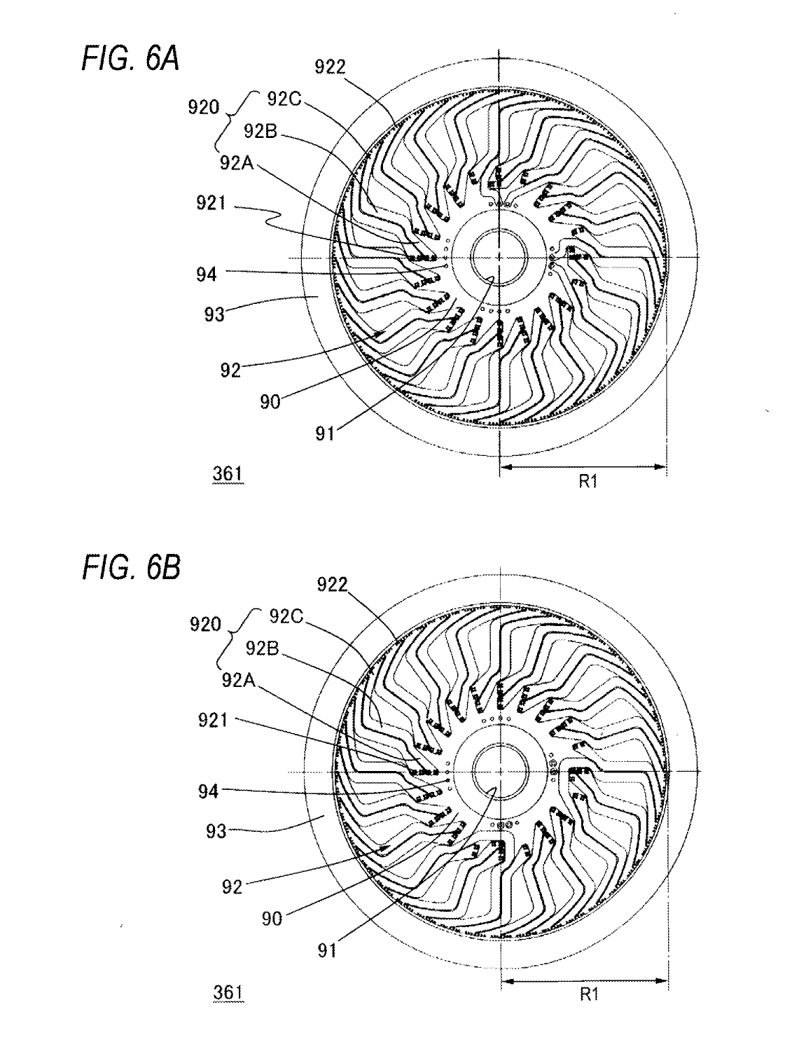

FIG. 6A is a plan view illustrating the first coil disk 361 illustrated in FIG. 4 and FIG. 6B is a bottom view illustrating the first coil disk 361 in FIG. 4. Since the other coil disks have the same configuration and pattern (coil pattern and balancing pattern) as the first coil disk 361, only the first coil disk 361 will be described herein.

The first coil disk 361 includes coil patterns 92 and a balancing pattern 93 as an outside pattern. The coil patterns are respectively provided on both surfaces of a disk-shaped insulating board 90 (for example, an insulating resin board such as a glass fiber reinforced epoxy resin board). The cylinder part 37A of FIG. 4 is inserted into a through-hole 91 which is provided in the center of the insulating board 90. A total of sixteen pin insertion holes 94 are formed in such a way that four pin insertion holes 94 are provided at an interval of every 90° around the center of the insulating board 90. A distance from each pin insertion hole 94 to the center of the insulating board 90 is equal to each other. Each pin insertion hole 94 is communicated with any one of the pin insertion holes 35B which are formed on the commutator board 35.

The coil pattern 92 is made of copper or other conductive materials and includes a group 920 of partial coil pattern composed by a pattern of two columns which are adjacent to each other and have substantially equal width. Twenty groups 920 of partial coil pattern are provided in both surfaces of the first coil disk, respectively. The group 920 of partial coil pattern is obtained by sequentially connecting a group 92A of inside connection pattern, a group 92B of radial pattern and a group 92C of outside connection pattern. The groups 92A of inside connection pattern on both surfaces are electrically connected to each other by a through-hole 921 which is formed in the vicinity of an end thereof. The groups 92C of outside connection pattern on both surfaces are electrically connected to each other by a through-hole 922 which is formed in the vicinity of an end thereof. The group 92B of radial pattern extends radially outward from a center side of the insulating board 90 and spans between the group 92A of inside connection pattern and the group 92C of outside connection pattern. The groups 92B of radial pattern on both surfaces are present in substantially the same position, as viewed in an axial direction.

The groups 92B of radial pattern on each surface are present in an equiangular pitch around the center of the insulating board 90. Accordingly, in a portion between adjacent groups 92B of radial pattern in a surface of the insulating board 90, there is an area that the coil pattern 92 does not exist.

Typically, the coil disk is made in a size of a minimum radius R1 to include the coil pattern 92. However, in the present embodiment, the coil disk is made in a size larger than the minimum radius R1 so that an outer periphery side of the coil pattern 92 (an outer periphery side of the group 92C of outside connection pattern) is ensured as a balancing area. Further, a balancing pattern 93 which is electrically insulated from the coil pattern 92 is provided on a ring-shaped balancing area. The balancing pattern 93 is made of the same material as the coil pattern 92. A height of the balancing pattern 93 from the insulating board 90 is substantially equal to a height of the coil pattern 92 from the insulating board 90. In the illustrated example, the balancing pattern 93 is formed in a continuous ring shape to surround the coil pattern 92. A balancing adjustment using the balancing area will be described later.

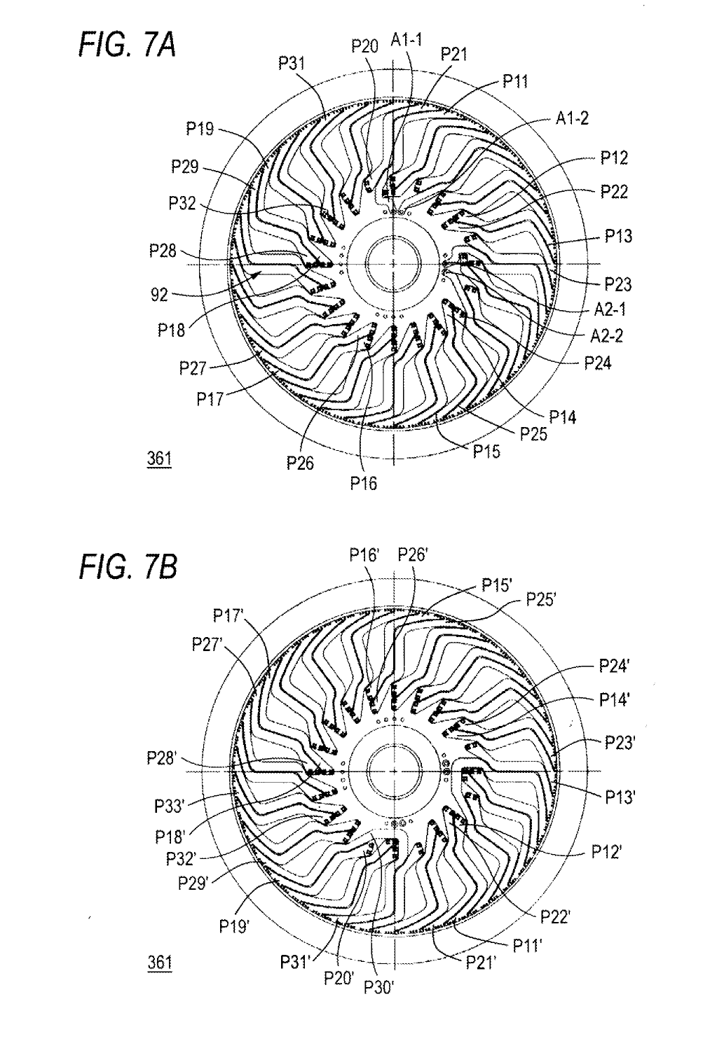

FIGS. 7A and 7B are views explaining a coil pattern of the first coil disk 361. FIGS. 7A and 7B are the same as FIGS. 6A and 6B, except for the symbols indicated. The coil pattern 92 of the first coil disk 361 includes two coils. In FIG. 7A, a starting point of one coil is represented as A1-1 and an ending point thereof is represented as A1-2. Further, in FIG. 7A, a starting point of the other coil is represented as A2-1 and an ending point thereof is represented as A2-2. The one coil continuously extends from the starting point A1-1 via points P11, P11′, P12′, P12, P13, P13′, . . . , P19′, P20′. In this way, the one coil goes round in a clockwise direction from the starting point A1-1, as seen from the above. And further, the one coil similarly continuously extends from the point P20′ via points P20, P21, P21′, P22′, P22, P23, P23′, . . . , P29′, P30′. In this way, the one coil goes round twice in a clockwise direction from the starting point A1-1, as seen from the above. Then, the one coil similarly continuously extends from the point P30′ via points P31, P31′, P32, P32′, P33′, . . . in a counterclockwise direction. And thus, the one coil goes round twice from the point P30′ and reaches the ending point Al-2. Similarly, the other coil continuously extends from starting point A21 to an ending point A2-2.

Four sheets of the first coil disk 361 to the fourth coil disk 364 thus configured are laminated in an axial direction (laminating direction) to form the coil part 36. The coils of the different coil disks are electrically connected to each other by the pin 40 which was described in FIG. 4. Twelve pins 40 are required for connecting four sheets of coil disks to each other. Herein, the coil patterns 92 formed on each coil disk can be connected in series by shifting (phase) an angle around the output shaft 31 of each coil disk in a predetermined angle.

Hereinafter, a method for manufacturing the disk motor 80 will be briefly described.

Etching is carried out in a state where both surfaces of a disk-shaped insulation board are laminated with a conductive material such as a copper foil and covered with a mask (etching process). Necessary through-hole or pin insertion hole is processed before or after the etching process. In this way, four coil disks 361 to 364 formed with the coil pattern 92 and the balancing pattern 93 (see, FIG. 6A) are obtained. Further, the commutator board 35 formed with the commutator pattern 351 (see, FIG. 5) is similarly obtained.

As illustrated in FIG. 4, each member is laminated on the flange 37 through the pin 40 in a state where sheet-like adhesive layers 501 to 503, 505, 507 (for example, thin sheet in a state where a glass fabric base material is impregnated with an epoxy resin and then semi-cured) in a prepreg state are interposed between layers. And then, the laminated member is set in a mold and subjected to a hot press (pressed in a lamination direction in a heated state) (adhesive process). Prior to the hot press, the pin 40 and each coil disk are soldered in a state where the coil disks 361 to 364 are laminated. Further, after the hot press, the commutator board 35 and the pin 40 are soldered and unnecessary projecting portion of the pin 40 is cut away. The rotor 82 of FIG. 4 thus obtained is combined with the stator 81 and the brush 83 and thus the disk motor 80 is completed.

In the present embodiment, it is possible to adjust the balance of the disk motor using the balancing area after assembling of the rotor is completed. Hereinafter, such a balance adjusting operation will be described.

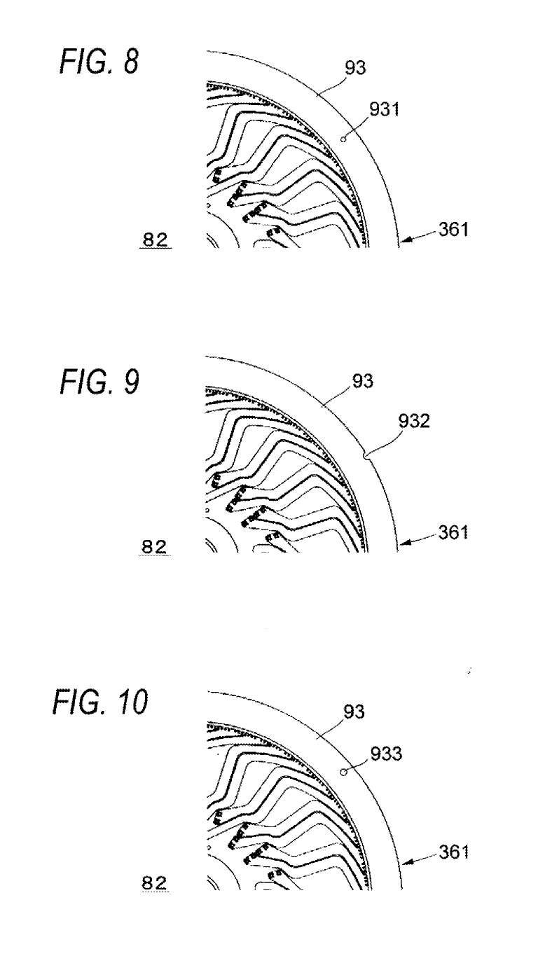

First, the balance measurement of the rotor 82 thus configured is carried out. The balance measurement can be carried out using a commercially available balancing machine. Unbalance (amount of unbalance and angular position of unbalance) of the rotor is specified by the balancing machine. Then, a balance adjustment is performed in order to reduce the unbalance. In the balance adjustment, when a minus balance method (minus correction) is employed, a balancing hole 931 (either through-hole or non-through hole) is provided in the balancing area (balancing pattern 93) by a drilling process (for example, see FIG. 8) or a balancing notch 932 is provided in the balancing area by a milling process (for example, see FIG. 9). Further, when a plus balance method (plus correction) is employed, a balancing protrusion 933 made of a conductive material is formed on the balancing pattern 93 (for example, see FIG. 10). For example, a solder bump is formed on the balancing pattern by soldering. The balance measurement and the balance adjustment may be repeated several times. Further, two or more of the balancing hole 931, the balancing notch 932 and the balancing protrusion 933 may be combined. In this way, it is possible to correct the unbalance of the rotor 82 and thus unbalance of the disk motor 80.

According to the present invention, the following effects can be achieved.

(1) Since the coil disk includes the balancing area which is provided to an outer periphery side of the coil pattern, it is possible to adjust the unbalance of the rotor 82 and thus unbalance of the disk motor 80 using the balancing area. Accordingly, the balance adjustment can be carried out at a position remote from the output shaft 31 and a large balance adjustment can be carried out with less amount of work (little processing). Further, the rotor 82 can be balanced after the assembling of the rotor is completed. In addition, it is possible to suppress increase in the number of parts and cost and also to maintain flatness (thinness) as a merit of the disk motor, as compared to a case where a separate component is added to adjust the balance.

(2) When it is considered that the balance adjustment is carried out at a region within the minimum radius R1 to include the coil pattern 92, disconnection of the coil pattern may be caused by the drilling process, for example, and short circuit of the coil pattern may be caused by the soldering process, for example. Accordingly, these processes are not practical. In particular, when a plurality of coil disks is laminated, the coil pattern 92 of inner layer is not visible and thus the balance adjustment at a region within the minimum radius R1 has greater risk. In contrast, in the present embodiment, since the coil disk is made in a size larger than the minimum radius R1 and thus an outer periphery of the coil pattern 92 is ensured as the balancing area, it is possible to safely adjust the balance using the balancing area.

(3) Since the balancing pattern 93 is formed in the balancing area, adhesive strength between the coil disks is high. That is, when the balancing pattern 93 does not exist, the balancing area is lower than the surface of the coil pattern 93 and thus less contributes (or does not contribute) to adhesion between the coil disks. Accordingly, there is a problem that adhesive strength between the coil disks is low. In contrast, in the present embodiment, since the balancing pattern 93 is provided and a height thereof from a board surface is substantially equal to a height of the coil pattern 92 from the board, the surface of the balancing pattern 93 also contributes to adhesion between the coil disks and thus adhesive strength therebetween is increased. Accordingly, it is possible to ensure high reliability, even in a high-vibration product or a product which is easily subjected to impact depending on using method.

(4) Since the balancing pattern 93 is provided, the balance adjustment by the plus balance method (plus correction) can be easily performed by soldering, etc.

(5) Since the balancing pattern 93 is made of the same material as the coil pattern 92 and a height thereof from a board surface is equal to a height of the coil pattern from the board, both the balancing pattern and the coil pattern can be formed at a time by one etching process. Accordingly, manufacturing is easier and cost is lower. That is, it is not necessary to add a separate process for forming the balancing pattern 93.

While description has been made in connection with particular embodiments of the present invention, it will be obvious to those skilled in the art that various changes and modifications may be made therein without departing from the scope of the present invention. Hereinafter, a modification thereof will be described.

The balancing pattern 93 may be arranged in such a way that a plurality of small patterns is arranged in a ring shape, instead of a continuous ring-shaped arrangement.

The balancing pattern 93 may be connected to the coil pattern 92, as long as short circuit (including partial short circuit) of the coil pattern 92 is not caused. That is, the balancing pattern 93 need not be insulated from the coil pattern 92.

The balancing pattern 93 may not be provided to a surface of the balancing area other than an adhesive surface with another coil disk. In this case, although the balance adjustment by the plus balance method becomes difficult, there is no impact to the adhesive force. Further, the balancing pattern 93 need not be provided to a portion of the balancing area on the adhesive surface, when the adhesive force is not strictly demanded.

Meanwhile, in a case of the balance adjustment by the plus balance method, the formation position of the balancing pattern is not limited to an outer periphery of the coil disk. For example, although an axial dimension may slightly increase, a balance adjustment disk with no coil pattern may be provided on an axially outermost side (upper side of the first coil disk 361) of the coil part 36 and the balancing pattern may be provided on an outer periphery side of the balance adjustment disk. In this case, the balancing pattern may be formed in a ring shape at a peripheral side of a portion of each coil disk facing the magnet.

One or all of the coil disks may be a single-sided board.

Although it is not essential that the shapes of the coil disk and the commutator board is formed in a precise discoid shape, it is preferable that the shapes falls within a range regarded as substantially circle, as viewed in an axial direction.

In addition, the number and arrangement pitch angle of the magnets, the winding numbers of the coil pattern (the column number of the coil pattern), the lamination number of the coil disks, the number of the pin insertion holes or through-holes and other parameters can be suitably set depending on a required performance or cost. Further, the winding numbers of the coil pattern may be different for each coil disk. When there is only one column of coil pattern, each term of “a group of partial coil pattern,” “a group of inside connection pattern,” “a group of radial pattern,” and “a group of outside connection pattern” in the description of the above embodiment should be replaced by omitting the word “a group of” therefrom.

The electric working machine may be various electric tools which include a rotational driving part driven by the disk motor, in addition to the mower described in the above embodiment. For example, the electric working tool may be a belt sander or a rotary band saw, to which the disk motor is mounted.

The present invention provides illustrative, non-limiting aspects as follows:

(1) In a first aspect, there is provided a disk motor including: a coil disk to which a coil pattern is formed; an electric current supply part configured to supply electric current to the coil pattern; a magnetic flux generating part opposed to the coil pattern; and an output shaft configured to be rotated by a rotational force of the coil disk, wherein the coil disk includes a balancing area at an outer periphery side of the coil pattern.

(2) In a second aspect, there is provided the disk motor according to the first aspect, wherein an outside pattern is formed to the balancing area.

(3) In a third aspect, there is provided the disk motor according to the first aspect, wherein the disk motor is configured such that a plurality of the coil disks are laminated, and wherein an outside pattern is formed to at least a portion of the balancing area of each coil disk, which opposes another coil disk.

(4) In a fourth aspect, there is provided the disk motor according to the first aspect, wherein an outside pattern made of a conductive material is formed to a portion of the balancing area which does not contact with another board, and wherein a protrusion made of a conductive material is provided on the outside pattern.

(5) In a fifth aspect, there is provided the disk motor according to any one of the second to fourth aspects, wherein the outside pattern is made of the same material as the coil pattern.

(6) In a sixth aspect, there is provided the disk motor according to any one of the second to fifth aspect, wherein the outside pattern is insulated from the coil pattern.

(7) In a seventh aspect, there is provided the disk motor according to any one of the second to sixth aspect, wherein a height of the outside pattern from a surface of the coil disk is substantially equal to a height of the coil pattern from the surface of the coil disk.

(8) In an eighth aspect, there is provided the disk motor according to any one of the first to seventh aspect, wherein a hole is formed to the balancing area.

(9) In a ninth aspect, there is provided the disk motor according to any one of the first to eighth aspect, wherein a notch is formed to the balancing area.

(10) In a tenth aspect, there is provided a disk motor including: a rotor including a commutator disk and at least one coil disk to which a coil pattern is formed; an electric current supply part configured to supply electric current to the coil pattern; a magnetic flux generating part opposed to the coil pattern; and an output shaft configured to be rotated by a rotational force of the coil disk, wherein the rotor includes a balancing area at an outer periphery portion thereof, wherein an outside pattern made of a conductive material is formed to a portion of the balancing area which is not a surface that contacts with another board, and wherein a protrusion made of a conductive material is provided on the outside pattern.

(11) In an eleventh aspect, there is provided an electric working machine including the disk motor according to any one of the first to tenth aspects.

(12) In a twelfth aspect, there is provided a method for adjusting balance of a disk motor, the disk motor including a coil disk to which a coil pattern is formed, an electric current supply part configured to supply electric current to the coil pattern, a magnetic flux generating part opposed to the coil pattern and an output shaft configured to be rotated by a rotational force of the coil disk, and the coil disk including a balancing area on an outer periphery side of the coil pattern, the method including; forming a hole or a notch to the balancing area.

(13) In a thirteenth aspect, there is provided a method for adjusting balance of a disk motor, the disk motor including a rotor having a commutator disk and at least one coil disk to which a coil pattern is formed, an electric current supply part configured to supply electric current to the coil pattern, a magnetic flux generating part opposed to the coil pattern and an output shaft configured to be rotated by a rotational force of the coil disk, the rotor including a balancing area at an outer periphery portion thereof, and an outside pattern is formed to a portion of the balancing area which is not a surface that contacts with another board, the method comprising: forming a protrusion made of a conductive material on the outside pattern.

Any combinations of the above components and a modification thereof are also effective as an embodiment of the present invention.

What is claimed is:

1. A disk motor comprising:
a coil disk to which a coil pattern is formed;
an electric current supply part configured to supply electric current to the coil pattern;
a magnetic flux generating part opposed to the coil pattern; and
an output shaft configured to be rotated by a rotational force of the coil disk,
wherein the coil disk includes a balancing area at an outer periphery side of the coil pattern.

2. The disk motor according to claim 1,
wherein an outside pattern is formed to the balancing area.

3. The disk motor according to claim 1,
wherein the disk motor is configured such that a plurality of the coil disks are laminated, and
wherein an outside pattern is formed to at least a portion of the balancing area of each coil disk, which opposes another coil disk.

4. The disk motor according to claim 1,
wherein an outside pattern made of a conductive material is formed to a portion of the balancing area which does not contact with another board, and
wherein a protrusion made of a conductive material is provided on the outside pattern.

5. The disk motor according to claim 2,
wherein the outside pattern is made of the same material as the coil pattern.

6. The disk motor according to claim 2,
wherein the outside pattern is insulated from the coil pattern.

7. The disk motor according to claim 2,
wherein a height of the outside pattern from a surface of the coil disk is substantially equal to a height of the coil pattern from the surface of the coil disk.

8. The disk motor according to claim 1,
wherein a hole is formed to the balancing area.

9. The disk motor according to claim 1,
wherein a notch is formed to the balancing area.

10. A disk motor comprising:
a rotor including a commutator disk and at least one coil disk to which a coil pattern is formed;
an electric current supply part configured to supply electric current to the coil pattern;
a magnetic flux generating part opposed to the coil pattern; and
an output shaft configured to be rotated by a rotational force of the coil disk,
wherein the rotor includes a balancing area at an outer periphery portion thereof,
wherein an outside pattern made of a conductive material is formed to a portion of the balancing area which is not a surface that contacts with another board, and
wherein a protrusion made of a conductive material is provided on the outside pattern.

11. An electric working machine comprising the disk motor according to claim 1.

12. A method for adjusting balance of a disk motor, the disk motor including a coil disk to which a coil pattern is formed, an electric current supply part configured to supply electric current to the coil pattern, a magnetic flux generating part opposed to the coil pattern and an output shaft configured to be rotated by a rotational force of the coil disk, and the coil disk including a balancing area on an outer periphery side of the coil pattern, the method comprising;
forming a hole or a notch to the balancing area.

13. A method for adjusting balance of a disk motor, the disk motor including a rotor having a commutator disk and at least one coil disk to which a coil pattern is formed, an electric current supply part configured to supply electric current to the coil pattern, a magnetic flux generating part opposed to the coil pattern and an output shaft configured to be rotated by a rotational force of the coil disk, the rotor including a balancing area at an outer periphery portion thereof, and an outside pattern is formed to a portion of the balancing area which is not a surface that contacts with another board, the method comprising:
forming a protrusion made of a conductive material on the outside pattern.
